(19) United States
(12) Patent Application Publication
(10) Pub. No.: US 2022/0261930 A1
(43) Pub. Date: Aug. 18, 2022

(54) INFORMATION PROCESSING APPARATUS, INFORMATION PROCESSING SYSTEM, NON-TRANSITORY COMPUTER READABLE MEDIUM, AND VEHICLE

(71) Applicant: TOYOTA JIDOSHA KABUSHIKI KAISHA, Toyota-shi (JP)

(72) Inventor: Daiki KANEICHI, Tokyo-to (JP)

(21) Appl. No.: 17/651,153

(22) Filed: Feb. 15, 2022

(30) Foreign Application Priority Data
Feb. 18, 2021 (JP) 2021-024576

(51) Int. Cl. G06Q 50/06; G06Q 40/04; G07C 5/08

(52) U.S. Cl. CPC G06Q 50/06; G07C 5/0841; G06Q 40/04

(57) ABSTRACT

An information processing apparatus includes a controller configured to acquire first information indicating an electricity trading price by time slot in a target period, acquire second information indicating a schedule of a vehicle in the target period, and determine, based on the first information and the second information, a time slot for selling at least a portion of surplus electrical energy stored in the vehicle.

### CROSS-REFERENCE TO RELATED APPLICATION

This application claims priority to Japanese Patent Application No. 2021-024576, filed on Feb. 18, 2021, the entire contents of which are incorporated herein by reference.

### TECHNICAL FIELD

The present disclosure relates to an information processing apparatus, an information processing system, a program, and a vehicle.

### BACKGROUND

Technology for supplying surplus electrical energy from a battery mounted in a vehicle to a power system is known. For example, patent literature (PTL) 1 discloses determining the electrical energy to supply from a secondary battery mounted in a vehicle to a power system, with the limit being the stored electrical energy yielded by subtracting the stored electrical energy that enables the vehicle to travel from the position of the vehicle to a specific point from the total stored electrical energy of the secondary battery.

### CITATION LIST

### Patent Literature

PTL 1: JP 2020-195203 A

### SUMMARY

Known technology does not, however, sufficiently consider the electricity trading price when, as a consumer, the user of the vehicle sells the surplus electrical energy from the vehicle battery.

It would be helpful to provide technology that enables electricity trading between a vehicle and an electrical power system, taking into account the electricity trading price that varies by time slot.

An information processing apparatus according to an embodiment of the present disclosure includes a controller configured to:

acquire first information indicating an electricity trading price by time slot in a target period;

acquire second information indicating a schedule of a vehicle in the target period; and

determine, based on the first information and the second information, a time slot for selling at least a portion of surplus electrical energy stored in the vehicle.

A program according to an embodiment of the present disclosure is configured to cause an information processing apparatus to execute operations, the operations including:

acquiring first information indicating an electricity trading price by time slot in a target period;

acquiring second information indicating a schedule of a vehicle in the target period; and

determining, based on the first information and the second information, a time slot for selling at least a portion of surplus electrical energy stored in the vehicle.

A vehicle according to an embodiment of the present disclosure includes a controller configured to:

acquire first information indicating an electricity trading price by time slot in a target period;

acquire second information indicating a schedule of the vehicle in the target period; and

determine, based on the first information and the second information, a time slot for selling at least a portion of surplus electrical energy stored in the vehicle.

The information processing apparatus, the information processing system, the program, and the vehicle according to an embodiment of the present disclosure enable electricity trading between a vehicle and an electrical power system, taking into account the electricity trading price that varies by time slot.

### BRIEF DESCRIPTION OF THE DRAWINGS

In the accompanying drawings:

FIG. 1 is a configuration diagram illustrating a configuration of an information processing system that includes an information processing apparatus according to an embodiment of the present disclosure;

FIG. 2 is functional block diagram illustrating schematic configurations of the information processing apparatus, a vehicle, and a server of FIG. 1;

FIG. 3 is a sequence diagram illustrating an example of an information processing method executed by the information processing system of FIG. 1;

FIG. 4 is a flowchart illustrating an example of an information processing method executed by the information processing apparatus of FIG. 1;

FIG. 5 is a first diagram illustrating an example of processing executed by the information processing apparatus of FIG. 1;

FIG. 6 is a second diagram illustrating an example of processing executed by the information processing apparatus of FIG. 1;

FIG. 7 is a third diagram illustrating an example of processing executed by the information processing apparatus of FIG. 1;

FIG. 8 is a fourth diagram illustrating an example of processing executed by the information processing apparatus of FIG. 1; and

FIG. 9 is a fifth diagram illustrating an example of processing executed by the information processing apparatus of FIG. 1.

### DETAILED DESCRIPTION

An embodiment of the present disclosure will be described below, with reference to the drawings.

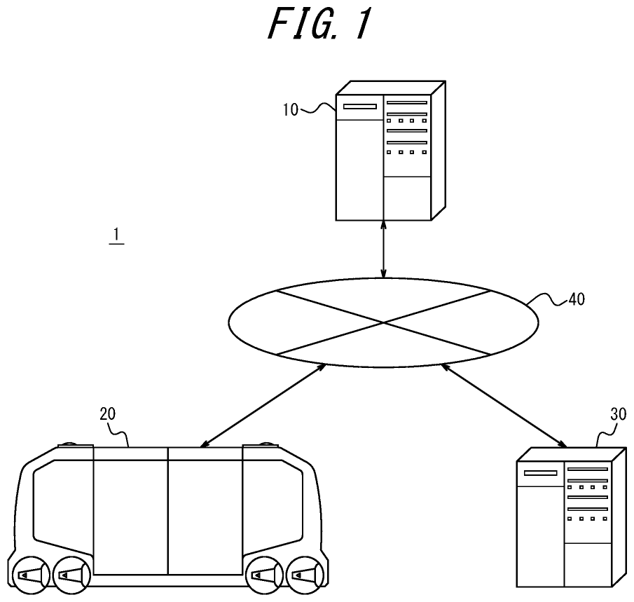

FIG. 1 is a configuration diagram illustrating a configuration of an information processing system 1 that includes an information processing apparatus 10 according to an embodiment of the present disclosure. Referring to FIG. 1, an outline of the information processing system 1 that includes the information processing apparatus 10 according to the embodiment of the present disclosure will be primarily described. The information processing system 1 includes a vehicle 20 and a server 30 in addition to the information processing apparatus 10.

For the sake of explanation, only one of each of the information processing apparatus 10, the vehicle 20, and the server 30 is illustrated in FIG. 1, but two or more of each of the information processing apparatus 10, the vehicle 20, and the server 30 may be included in the information processing system 1. Each of the information processing apparatus 10, the vehicle 20, and the server 30 is communicably connected to a network 40 including, for example, a mobile communication network and the Internet.

The information processing apparatus 10 is a single server apparatus or a plurality of server apparatuses that can communicate with each other. The information processing apparatus 10 is not limited to these, and may be any general purpose electronic device such as a personal computer (PC) or a smartphone, or may be any other electronic device that is dedicated to the information processing system 1.

The vehicle 20 is, for example, an electric vehicle. The vehicle 20 is not limited to this and may be any vehicle on which a person can board to drive to a destination. The vehicle 20 is, for example, any vehicle driven by a driver. The vehicle 20 is not limited to a vehicle driven by a driver and may, for example, be a vehicle that performs automated driving. The automated driving may include any level from Level 1 to Level 5 as defined by the Society of Automotive Engineers (SAE), for example, but is not limited to these, and may be defined in any way.

The server 30 is a single server apparatus or a plurality of server apparatuses that can communicate with each other.

To summarize an embodiment, the information processing apparatus 10 acquires first information indicating an electricity trading price by time slot in a target period. In the present specification, the “target period” includes, for example, one day from 0:00 to 24:00. The “first information” includes, for example, the electricity trading price during each predetermined time slot for each target period.

The information processing apparatus 10 acquires second information indicating a schedule of the vehicle 20 in a target period. In the present specification, the “schedule” may be a usage mode of the vehicle 20, such as traveling during a predetermined time slot, or may be a change over time in the stored electrical energy in the battery mounted in the vehicle 20 or a predicted value thereof.

Based on the first information and the second information, the information processing apparatus 10 determines a time slot for selling at least a portion of the surplus electrical energy stored in the vehicle 20.

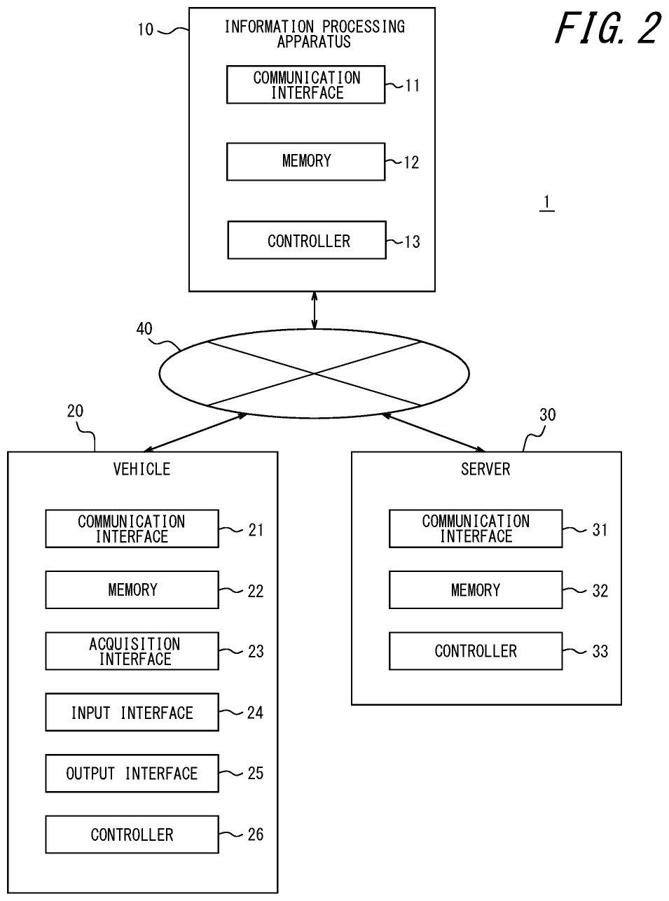

Next, referring to FIG. 2, the configuration of each of the information processing apparatus 10, the vehicle 20, and the server 30 included in the information processing system 1 is mainly described. FIG. 2 is a functional block diagram illustrating schematic configurations of the information processing apparatus 10, the vehicle 20, and the server 30 of FIG. 1.

As illustrated in FIG. 2, the information processing apparatus 10 includes a communication interface 11, a memory 12, and a controller 13.

The communication interface 11 includes a communication module connected to the network 40. For example, the communication interface 11 may include a communication module compliant with mobile communication standards such as the 4th generation (4G) and the 5th generation (5G) standards or with Internet standards. In an embodiment, the information processing apparatus 10 is connected to the network 40 via the communication interface 11. The communication interface 11 transmits and receives various information via the network 40.

The memory 12 is, for example, a semiconductor memory, a magnetic memory, an optical memory, or the like, but is not limited to these. The memory 12 may function as, for example, a main memory, an auxiliary memory, or a cache memory. The memory 12 stores any information used for operations of the information processing apparatus 10. For example, the memory 12 may store a system program, an application program, and various information transmitted or received by the communication interface 11. The information stored in the memory 12 may be updated with information received from the network 40 via the communication interface 11, for example.

The controller 13 includes at least one processor. The “processor” is a general purpose processor or a dedicated processor that is dedicated to specific processing in an embodiment but is not limited to these. The controller 13 is connected to each component included in the information processing apparatus 10 so as to communicate with each component and controls operation of the entire information processing apparatus 10.

Next, the configuration of the vehicle 20 included in the information processing system 1 is mainly described. As illustrated in FIG. 2, the vehicle 20 includes a communication interface 21, a memory 22, an acquisition interface 23, an input interface 24, an output interface 25, and a controller 26. The communication interface 21, the memory 22, the acquisition interface 23, the input interface 24, the output interface 25, and the controller 26 are communicably connected to each other via an in-vehicle network, such as a Controller Area Network (CAN), or a dedicated line.

The communication interface 21 includes a communication module connected to the network 40. For example, the communication interface 21 may include a communication module compliant with mobile communication standards such as the 4G and the 5G standards. In an embodiment, the vehicle 20 is connected to the network 40 via the communication interface 21. The communication interface 21 transmits and receives various information via the network 40.

The memory 22 is, for example, a semiconductor memory, a magnetic memory, an optical memory, or the like, but is not limited to these. The memory 22 may function as, for example, a main memory, an auxiliary memory, or a cache memory. The memory 22 stores any data used for the operations of the vehicle 20. For example, the memory 22 may store a system program, an application program, and various information transmitted or received by the communication interface 21. The information stored in the memory 22 may be updated with information received from the network 40 via the communication interface 21, for example.

The acquisition interface 23 includes any sensor module capable of acquiring fuel efficiency information of the vehicle 20. In the present specification, the “fuel efficiency information” includes, for example, the distance traveled per unit capacity of the power source, which is the electricity supplied from the battery mounted in the vehicle 20. For example, the fuel efficiency information includes the electricity efficiency of the vehicle 20 as an electric vehicle and includes the distance traveled per kWh of the battery. At this time, the acquisition interface 23 may include a sensor module capable of measuring changes in the stored electrical energy in the battery of the vehicle 20 with respect to the distance traveled by the vehicle 20.

The acquisition interface 23 includes any sensor module capable of acquiring the third information on the vehicle 20. In the present specification, the “third information” includes any information that indicates, for example, a power usage tendency in the vehicle 20. The third information includes any information indicating not only a power usage tendency based on driving of the vehicle 20, but also a power usage tendency based on in-vehicle actions such as audio operations and air conditioning operations by a user of the vehicle 20. The acquisition interface 23 may include a sensor module capable of measuring changes in the stored electrical energy in the battery of the vehicle 20.

The acquisition interface 23 includes any sensor module capable of acquiring driving information indicating a driving tendency of the vehicle 20 by the driver. In the present specification, the “driving tendency” includes, for example, the tendency of the driver to operate the accelerator, brake, clutch, turn signals, gears, wipers, door mirrors, audio, lights, steering wheel, air conditioner, and the like when driving the vehicle 20. The acquisition interface 23 may include any sensors connected to the CAN. The sensors include, for example, any sensor capable of acquiring driving information indicating the above-described driving tendencies, such as a speed sensor, an acceleration sensor, a steering wheel angle sensor, and an in-vehicle camera mounted in the cabin of the vehicle 20.

The acquisition interface 23 includes at least one receiver compliant with any appropriate satellite positioning system. For example, the acquisition interface 23 may include a Global Positioning System (GPS) receiver. The acquisition interface 23 acquires a measured value of the position of the vehicle 20 as the positional information. The positional information includes, for example, an address, a latitude, a longitude, an altitude, and the like. The acquisition interface 23 may acquire the positional information for the vehicle 20 continually, periodically, or non-periodically.

The input interface 24 includes, for example, at least one input interface that accepts an input operation by a user in the cabin of the vehicle 20 and acquires input information based on the input operation by the user. For example, the input interface 24 includes an input interface that forms part of a car navigation device. For example, the input interface 24 includes a touchscreen integrated with a liquid crystal monitor that forms part of a car navigation device. The input interface 24 receives an input operation by the user based on a touch operation by the user, for example.

The input interface 24 is not limited to these examples and may include any input interface capable of detecting an input operation by a user and acquiring input information based on the input operation by the user. The input interface 24 may, for example, include a physical key, a capacitive key, or a microphone for receiving audio input.

The output interface 25 includes at least one output interface that outputs information to a user in the cabin of the vehicle 20. For example, the output interface 25 includes an output interface that forms part of a car navigation device. For example, the output interface 25 includes a liquid crystal monitor that forms part of a car navigation device. The output interface 25 outputs information by image and/or audio, for example.

The output interface 25 is not limited to these examples and may include any output interface that stimulates the sense of sight and/or hearing of a user of the vehicle 20. The output interface 25 may, for example, include any other audio output interface, other than a car navigation device, that primarily stimulates the sense of hearing of the user of the vehicle 20. The output interface 25 may, for example, include any other image output interface, other than a car navigation device, that primarily stimulates the sense of sight of the user of the vehicle 20.

The controller 26 includes at least one processor. The “processor” is a general purpose processor or a dedicated processor that is dedicated to specific processing in an embodiment but is not limited to these. For example, the controller 26 may include an Electronic Control Unit (ECU). The controller 26 is communicably connected to the components of the vehicle 20 and controls operations of the entire vehicle 20.

Next, the configuration of the server 30 included in the information processing system 1 is mainly described. As illustrated in FIG. 2, the server 30 includes a communication interface 31, a memory 32, and a controller 33.

The communication interface 31 includes a communication module connected to the network 40. For example, the communication interface 31 may include a communication module compliant with mobile communication standards such as the 4G and the 5G standards or Internet standards. In an embodiment, the server 30 is connected to the network 40 via the communication interface 31. The communication interface 31 transmits and receives various information via the network 40.

The memory 32 is, for example, a semiconductor memory, a magnetic memory, an optical memory, or the like, but is not limited to these. The memory 32 may function as, for example, a main memory, an auxiliary memory, or a cache memory. The memory 32 stores any information used for operations of the server 30. For example, the memory 32 may store a system program, an application program, and various information transmitted or received by the communication interface 31. The information stored in the memory 32 may be updated with information received from the network 40 via the communication interface 31, for example.

The controller 33 includes at least one processor. The “processor” is a general purpose processor or a dedicated processor that is dedicated to specific processing in an embodiment but is not limited to these. The controller 33 is communicably connected to the components of the server 30 and controls operations of the entire server 30.

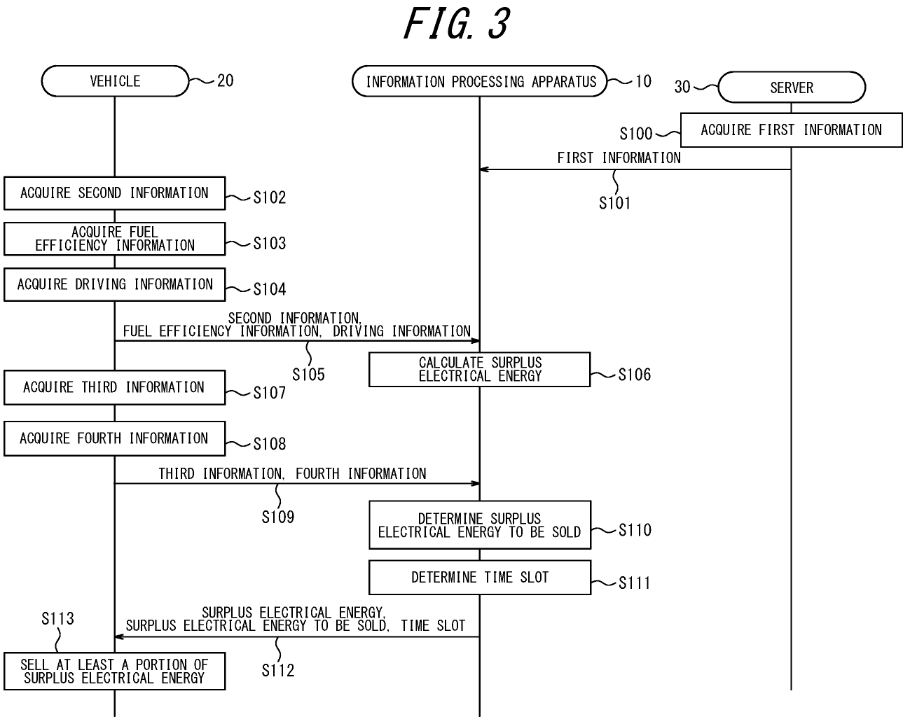

FIG. 3 is a sequence diagram illustrating an example of an information processing method executed by the information processing system 1 of FIG. 1. An example of an information processing method executed by the information processing system 1 of FIG. 1 is described with reference to FIG. 3. The sequence diagram in FIG. 3 illustrates the basic processing flow in the information processing method performed by the information processing system 1.

In step S100, the controller 33 of the server 30 acquires the first information indicating the electricity trading price by time slot in the target period. For example, the controller 33 of the server 30 acquires the first information for 0:00 to 24:00 of the next day on the current day.

In step S101, the controller 33 of the server 30 transmits the first information acquired in step S100 to the information processing apparatus 10, via the communication interface 31 and the network 40, on the current day. The controller 13 of the information processing apparatus 10 thereby acquires the first information from the server 30 on the current day.

In step S102, the controller 26 of the vehicle 20 acquires the second information indicating the schedule of the vehicle 20 in the target period. For example, the controller 26 of the vehicle 20 may acquire, on the current day, second information indicating the schedule from 0:00 to 24:00 of the next day based on input provided by a user of the vehicle 20 using the input interface 24. For example, the controller 26 of the vehicle 20 may acquire, on the current day, a schedule registered via an application on a terminal apparatus, such as a smartphone, used by a user of the vehicle 20 as the second information via the communication interface 21.

In step S103, the controller 26 of the vehicle 20 acquires fuel efficiency information on the vehicle 20 using the acquisition interface 23.

In step S104, the controller 26 of the vehicle 20 acquires, using the acquisition interface 23, driving information indicating a driving tendency of the vehicle 20 by the driver.

In step S105, the controller 26 of the vehicle 20 transmits the second information, the fuel efficiency information, and the driving information respectively acquired in steps S102 to S104 to the information processing apparatus 10, via the communication interface 21 and the network 40, on the current day. The controller 13 of the information processing apparatus 10 thereby acquires the second information, the fuel efficiency information, and the driving information from the vehicle 20 on the current day.

In step S106, the controller 13 of the information processing apparatus 10 calculates the surplus electrical energy stored in the vehicle 20 based on the second information and the fuel efficiency information acquired in step S105. For example, the controller 13 of the information processing apparatus 10 calculates the expected surplus electrical energy on the next day based on the second information and the fuel efficiency information, assuming that the battery of the vehicle 20 is fully charged on the current day.

In step S107, the controller 26 of the vehicle 20 acquires, using the acquisition interface 23, third information indicating a power usage tendency in the vehicle 20.

In step S108, the controller 26 of the vehicle 20 acquires fourth information indicating a preference of the user of the vehicle 20 regarding the sale of the surplus electrical energy. In the present specification, the “fourth information” includes, for example, the preference of the user of the vehicle 20 regarding the percentage of the surplus electrical energy actually to be sold to the surplus electrical energy calculated in step S106. The fourth information includes, for example, selection information when the user selects, using the input interface 24, items in a questionnaire format such as “I want to sell it all,” “No preference,” and “I want to sell, but with plenty remaining,” which the controller 26 of the vehicle 20 displays on a screen using the output interface 25.

In step S109, the controller 26 of the vehicle 20 transmits the third information and the fourth information acquired in steps S107 and S108, respectively, to the information processing apparatus 10 via the communication interface 21 and the network 40 on the current day. As a result, the controller 13 of the information processing apparatus 10 acquires the third information and the fourth information from the vehicle 20 on the current day.

In step S110, the controller 13 of the information processing apparatus 10 determines, based on the third information and/or the fourth information acquired in step S109, the surplus electrical energy to be sold among the surplus electrical energy calculated in step S106.

In step S111, the controller 13 of the information processing apparatus 10 determines, based on the first information acquired in step S101 and the second information acquired in step S105, a time slot on the next day in which at least a portion of the surplus electrical energy stored in the vehicle 20 is to be sold.

In step S112, the controller 13 of the information processing apparatus 10 transmits the calculation of the surplus electrical energy as calculated in step S106, the determination of the surplus electrical energy to be sold as determined in step S110, and the time slot determined in step S111 to the vehicle 20 via the communication interface 11 and the network 40 on the current day. The controller 26 of the vehicle 20 thereby acquires these pieces of information from the information processing apparatus 10 on the current day.

In step S113, the controller 26 of the vehicle 20 sells at least a portion of the surplus electrical energy, i.e., of the surplus electrical energy to be sold, in the time slot of the next day acquired in step S112. At this time, the controller 26 of the vehicle 20 may automatically sell the surplus electrical energy in the time slot of the next day acquired in step S112. This configuration is not limiting, however, and the controller 26 of the vehicle 20 may execute a notification process that prompts the user of the vehicle 20, via the output interface 25 or a terminal device such as a smartphone used by the user of the vehicle 20, to approve the sale of the surplus electrical energy.

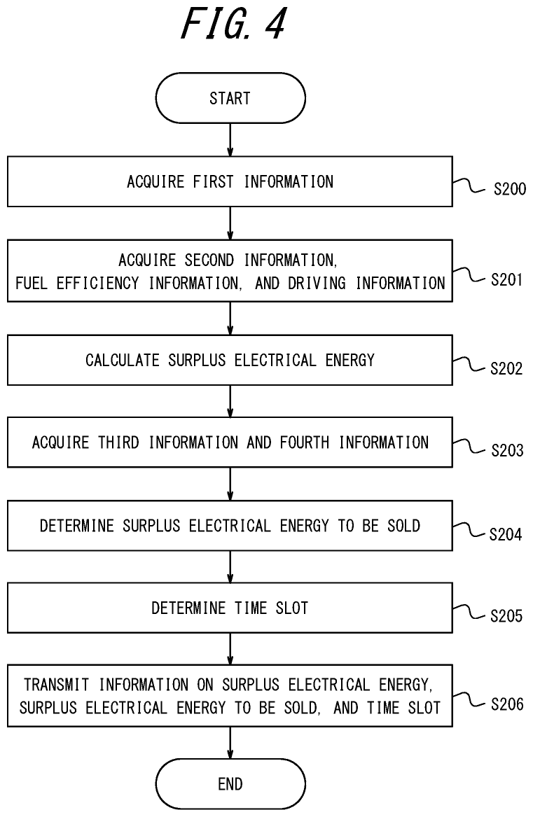

FIG. 4 is a flowchart illustrating an example of an information processing method executed by the information processing apparatus 10 of FIG. 1. An example of an information processing method executed by the information processing apparatus 10 of FIG. 1 is described with reference to FIG. 4. The flowchart in FIG. 4 illustrates the flow of basic processing of the information processing method executed by the information processing apparatus 10.

In step S200, the controller 13 acquires the first information indicating the electricity trading price by time slot in the target period from the server 30.

In step S201, the controller 13 acquires the second information indicating the schedule of the vehicle 20 in the target period from the vehicle 20. The controller 13 acquires fuel efficiency information for the vehicle 20 from the vehicle 20. The controller 13 acquires driving information, indicating a driving tendency of the vehicle 20 by the driver, from the vehicle 20.

In step S202, the controller 13 calculates the surplus electrical energy stored in the vehicle 20 based on the second information and the fuel efficiency information acquired in step S201. At this time, during calculation of the surplus electrical energy, the controller 13 may correct the fuel efficiency information based on the driving information acquired in step S201.

In step S203, the controller 13 acquires third information indicating a power usage tendency in the vehicle 20. The controller 13 acquires fourth information indicating a preference of the user of the vehicle 20 regarding the sale of the surplus electrical energy.

In step S204, the controller 13 determines, based on the third information and/or the fourth information acquired in step S203, the surplus electrical energy to be sold among the surplus electrical energy calculated in step S202.

In step S205, the controller 13 determines, based on the first information acquired in step S200 and the second information acquired in step S201, a time slot for selling at least a portion of the surplus electrical energy stored in the vehicle 20.

For example, the controller 13 may determine a first time slot with the highest electricity trading price among the time slots in which the vehicle 20 is connected to the electricity port during the target period as the time slot for selling at least a portion of the surplus electricity amount. For example, the controller 13 may determine, when the surplus electrical energy includes surplus electrical energy that is not sold during the first time slot, a second time slot for selling at least a portion of the surplus electrical energy that is not sold during the first time slot. For example, the controller 13 may determine the time slot with the second highest electricity trading price as the second time slot.

In step S206, the controller 13 transmits the calculation of the surplus electrical energy as calculated in step S202, the determination of the surplus electrical energy to be sold as determined in step S204, and the time slot determined in step S205 to the vehicle 20 via the communication interface 11 and the network 40.

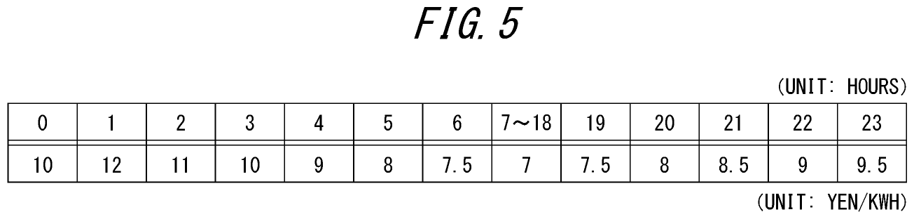

FIG. 5 is a first diagram for illustrating an example of processing executed by the information processing apparatus 10 of FIG. 1. FIG. 5 represents first information, acquired by the controller 13 of the information processing apparatus 10 from the server 30, illustrating an example of the electricity trading price by time slot during the target period on the next day.

For example, the controller 13 acquires information that the electricity trading price, i.e., the electricity sale price when selling at least a portion of the surplus electrical energy stored in the vehicle 20, is 10 yen/kWh between midnight and 1:00 on the next day. Similarly, the controller 13 acquires information that the electricity sale price is 12 yen/kWh between 1:00 and 2:00 on the next day. Similarly, the controller 13 acquires information that the electricity sale price is 11 yen/kWh between 2:00 and 3:00 on the next day.

Similarly below, the controller 13 acquires information that the price is 10 yen/kWh between 3:00 and 4:00, 9 yen/kWh between 4:00 and 5:00, 8 yen/kWh between 5:00 and 6:00, and 7.5 yen/kWh between 6:00 and 7:00. Furthermore, the controller 13 acquires information that the price is 7 yen/kWh between 7:00 and 19:00. The controller 13 acquires information that the rate is 7.5 yen/kWh between 19:00 and 20:00, 8 yen/kWh between 20:00 and 21:00, 8.5 yen/kWh between 21:00 and 22:00, 9 yen/kWh between 22:00 and 23:00, and 9.5 yen/kWh between 23:00 and 24:00.

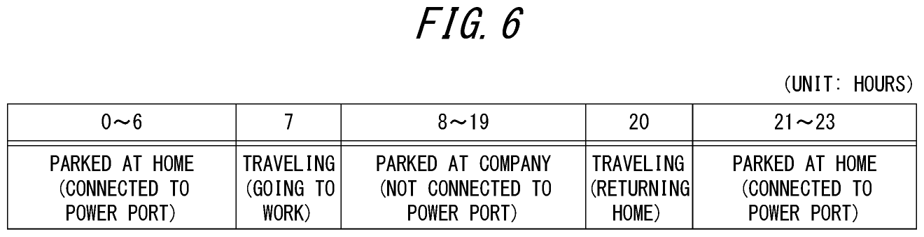

FIG. 6 is a second diagram for illustrating an example of processing executed by the information processing apparatus 10 of FIG. 1. FIG. 6 represents second information, acquired by the controller 13 of the information processing apparatus 10 from the vehicle 20, illustrating an example of the schedule of the vehicle 20 during the target period.

For example, the controller 13 acquires information that between midnight and 7:00 on the next day, the vehicle 20 will be parked at the user's home and connected to the power system via a power port. Similarly, the controller 13 acquires information that the vehicle 20 will travel between 7:00 and 8:00 on the next day for the user to go to work. The controller 13 acquires information that between 8:00 and 20:00 on the next day, the vehicle 20 will parked in the parking lot of the company where the user works and will not be connected to a power port. The controller 13 acquires information that the vehicle 20 will travel between 20:00 and 21:00 on the following day for the user to return home. The controller 13 acquires information that the vehicle 20 will be parked at the user's home and connected to the power system via the power port between 21:00 and 24:00 on the next day.

Based on the first information as illustrated in FIG. 5 and the second information as illustrated in FIG. 6, for example, the controller 13 selects a time slot, from among the time slots in which the vehicle 20 is connected to the power port during the target period, for selling at least a portion of the surplus electrical energy. For example, the controller 13 may determine a first time slot with the highest electricity trading price, i.e., between 1:00 and 2:00 on the next day, as the time slot for selling at least a portion of the surplus electrical energy stored in the vehicle 20.

At this time, depending on the power that can be outputted from the vehicle 20 to the power port, for example, it might be the case that the surplus electrical energy to be sold cannot all be sold in the first time slot. The controller 13 may determine, when the surplus electrical energy includes surplus electrical energy that is not sold during the first time slot, a second time slot for selling at least a portion of the surplus electrical energy that is not sold during the first time slot. For example, the controller 13 may determine the time slot between 2:00 and 3:00 on the next day, when the electricity trading price is second highest, as the second time slot.

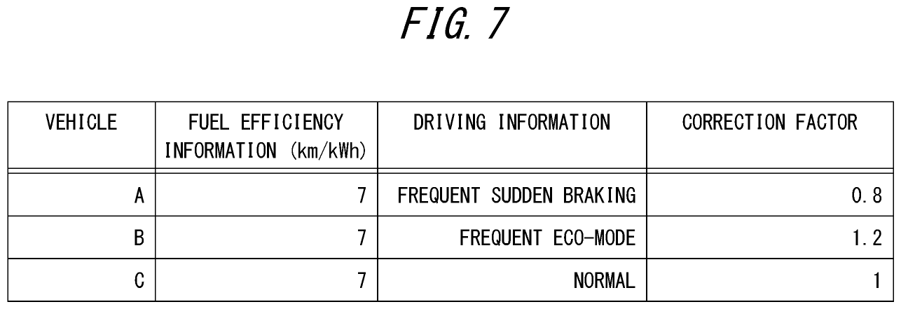

FIG. 7 is a third diagram for illustrating an example of processing executed by the information processing apparatus 10 of FIG. 1. FIG. 7 illustrates an example of a correction process when the controller 13 of the information processing apparatus 10 corrects the fuel efficiency information, during calculation of the surplus electrical energy, based on the driving information acquired from the vehicle 20. In FIG. 7, correction processing for three vehicles A, B, and C is illustrated as an example, but the number of vehicles 20 for which the controller 13 of the information processing apparatus 10 executes the correction processing is not limited to three.

The controller 13 acquires the fuel efficiency information for the vehicle 20 and calculates the surplus electrical energy based on the second information and the fuel efficiency information. The controller 13 refers to the electricity efficiency of the vehicle 20, included in the fuel efficiency information, to calculate the consumption during a time slot in the schedule of the vehicle 20 when the battery of the vehicle 20 needs to consume electricity. The controller 13 may calculate the surplus electrical energy by, for example, subtracting the consumption from the stored electrical energy of the battery when the battery is fully charged. For example, based on the schedule of the vehicle 20 illustrated in FIG. 6, the controller 13 may calculate the surplus electrical energy by subtracting the consumption required for the vehicle 20 to travel during the hours of 7:00 to 8:00 and 20:00 to 21:00 on the next day from the stored electrical energy when the battery is fully charged.

The controller 13 acquires, for example, information indicating 7 km/kWh as the fuel efficiency information for the vehicle A from the vehicle A. The controller 13 also acquires, as driving information indicating a driving tendency of the vehicle A by the driver, information that the driver often brakes suddenly. At this time, the controller 13 estimates that the electricity efficiency of the vehicle A is actually worse, based on the driving information that the driver often brakes suddenly, and determines 0.8 as a correction factor, for example. The controller 13 may correct the fuel efficiency information based on the driving information during the above-described calculation of the surplus electrical energy by multiplying such a correction factor by the electricity efficiency of the vehicle A.

The controller 13 acquires, for example, information indicating 7 km/kWh as the fuel efficiency information for the vehicle B from the vehicle B. The controller 13 also acquires, as driving information indicating a driving tendency of the vehicle B by the driver, information that the vehicle B is often driven in eco mode. At this time, the controller 13 estimates that the electricity efficiency of the vehicle B is actually better, based on the driving information that the vehicle B is often driven in eco mode, and determines 1.2 as a correction factor, for example. The controller 13 may correct the fuel efficiency information based on the driving information during the above-described calculation of the surplus electrical energy by multiplying such a correction factor by the electricity efficiency of the vehicle B.

The controller 13 acquires, for example, information indicating 7 km/kWh as the fuel efficiency information for the vehicle C from the vehicle C. The controller 13 also acquires, as driving information indicating a driving tendency of the vehicle C by the driver, information indicating normal driving. At this time, the controller 13 estimates that the electricity efficiency of the vehicle C differs little from the actual value, based on the driving information indicating normal driving, and determines 1 as a correction factor, for example. The controller 13 may correct the fuel efficiency information based on the driving information during the above-described calculation of the surplus electrical energy by multiplying such a correction factor by the electricity efficiency of the vehicle C. At this time, the controller 13 does not substantially correct the fuel efficiency information.

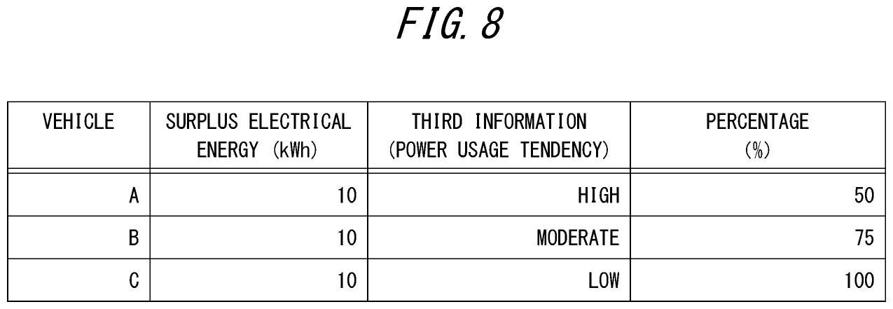

FIG. 8 is a fourth diagram for illustrating an example of processing executed by the information processing apparatus 10 of FIG. 1. FIG. 8 illustrates an example process when the controller 13 of the information processing apparatus 10 determines the surplus electrical energy actually to be sold among the calculated surplus electrical energy. A determination process for three vehicles A, B, and C is illustrated as an example in FIG. 8, but the number of vehicles 20 for which the controller 13 of the information processing apparatus 10 executes the determination process is not limited to three.

The controller 13 calculates, for example, a surplus electrical energy of 10 kWh for the vehicle A by the calculation process described above. The controller 13 also acquires, from the vehicle A, information that the power usage tendency in the vehicle A is high as the third information. For example, the power usage tendency in the vehicle A increases when the user of the vehicle A uses the air conditioning in the cabin for a long time or uses the audio frequently in addition to driving the vehicle A. The controller 13 determines the surplus electrical energy to be sold among the calculated surplus electrical energy of 10 kWh based on such third information. For example, the controller 13 may determine that since the user of the vehicle A tends to use more electricity, it is better to keep a certain percentage of the surplus electric power instead of selling all of it. The controller 13 may thus determine that 50% of the surplus electric power is to be sold.

The controller 13 calculates, for example, a surplus electrical energy of 10 kWh for the vehicle B by the calculation process described above. The controller 13 also acquires, from the vehicle A, information that the power usage tendency in the vehicle B is moderate as the third information. For example, the power usage tendency in the vehicle B remains moderate when the user of the vehicle B uses the air conditioning in the cabin in a normal manner or uses the audio in a normal manner in addition to driving the vehicle B. The controller 13 determines the surplus electrical energy to be sold among the calculated surplus electrical energy of 10 kWh based on such third information. For example, the controller 13 may determine that since the user of the vehicle B tends to electricity in a normal manner, it suffices to keep only a portion of the surplus electric power. The controller 13 may thus determine that 75% of the surplus electric power is to be sold.

The controller 13 calculates, for example, a surplus electrical energy of 10 kWh for the vehicle C by the calculation process described above. The controller 13 also acquires, from the vehicle C, information that the power usage tendency in the vehicle C is low as the third information. For example, the power usage tendency in the vehicle C is low when the user of the vehicle C uses very little electricity in the cabin other than for driving the vehicle C. The controller 13 determines the surplus electrical energy to be sold among the calculated surplus electrical energy of 10 kWh based on such third information. For example, the controller 13 may determine that since the user of the vehicle C tends to use very little electricity, it poses no problem to sell all of the surplus electrical energy. The controller 13 may thus determine that 100% of the surplus electrical energy is to be sold.

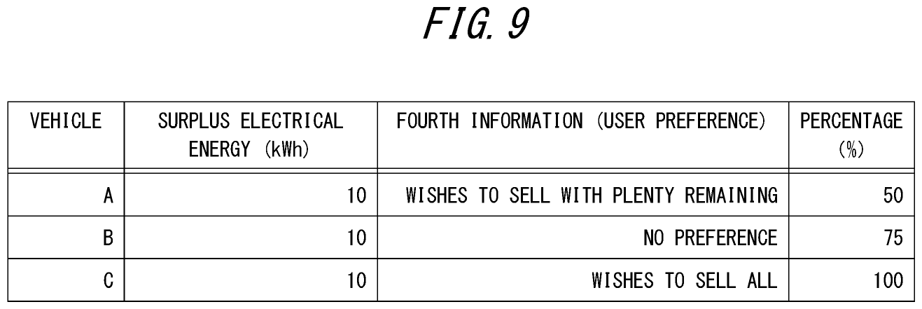

FIG. 9 is a fifth diagram for illustrating an example of processing executed by the information processing apparatus 10 of FIG. 1. FIG. 9 illustrates an example process when the controller 13 of the information processing apparatus 10 determines the surplus electrical energy actually to be sold among the calculated surplus electrical energy. A determination process for three vehicles A, B, and C is illustrated as an example in FIG. 9, but the number of vehicles 20 for which the controller 13 of the information processing apparatus 10 executes the determination process is not limited to three.

The controller 13 calculates, for example, a surplus electrical energy of 10 kWh for the vehicle A by the calculation process described above. Additionally, the controller 13 acquires, from the vehicle A, fourth information indicating the preference of the user of the vehicle A to sell the surplus electrical energy but with plenty remaining. The controller 13 determines the surplus electrical energy to be sold among the calculated surplus electrical energy of 10 kWh based on such fourth information. For example, the controller 13 may determine that 50% of the surplus electric power is to be sold, since the user of the vehicle A wishes to keep a certain percentage of the surplus electric power instead of selling all of it.

The controller 13 calculates, for example, a surplus electrical energy of 10 kWh for the vehicle B by the calculation process described above. Additionally, the controller 13 acquires, from the vehicle A, fourth information indicating that the user of the vehicle B has no preference with regard to sale of the surplus electrical energy. The controller 13 determines the surplus electrical energy to be sold among the calculated surplus electrical energy of 10 kWh based on such fourth information. For example, the controller 13 may determine that 75% of the surplus electrical energy is to be sold, since the user of the vehicle B is not particular about the sale of the surplus electrical energy.

The controller 13 calculates, for example, a surplus electrical energy of 10 kWh for the vehicle C by the calculation process described above. Additionally, the controller 13 acquires, from the vehicle C, fourth information indicating the preference of the user of the vehicle C to sell all of the surplus electrical energy. The controller 13 determines the surplus electrical energy to be sold among the calculated surplus electrical energy of 10 kWh based on such fourth information. For example, the controller 13 may determine that 100% of the surplus electric power is to be sold, since the user of the vehicle C wishes to sell all of the surplus electric power.

The above embodiment enables electricity trading between the vehicle 20 and an electrical power system, taking into account the electricity trading price that varies by time slot. For example, when the information processing apparatus 10 determines a time slot for selling at least a portion of the surplus electrical energy based on the first information and the second information, surplus electrical energy can be sold during an optimal time slot for the user of the vehicle 20 while considering the schedule of the vehicle 20 and the electricity trading price that varies by time slot. The information processing apparatus 10 can implement electricity trading, using the vehicle 20, that takes into consideration the electricity trading price through dynamic pricing.

When the information processing apparatus 10 determines the first time slot with the highest electricity trading price as the time slot for selling at least a portion of the surplus electrical energy, the user of the vehicle 20 can sell the surplus electrical energy during a time slot, among time slots when the vehicle 20 is connected to the power port, in which the supply is insufficient for the demand. Therefore, the information processing apparatus 10 can contribute to maintaining the balance between power supply and demand by supporting the sale of surplus electric power from the vehicle 20 during such time slots. The information processing apparatus 10 can, in other words, help to prevent the power supply and demand from becoming out of balance. Additionally, the profit earned by the user of the vehicle 20 from the sale of the surplus electrical energy is maximized.

The information processing apparatus 10 determines, when the surplus electrical energy includes surplus electrical energy that is not sold during the first time slot, a second time slot for selling at least a portion of the surplus electrical energy that is not sold during the first time slot. Consequently, if the surplus electrical energy that can be sold in the first time slot is limited for reasons such as the specifications of the power port, the user can still sell the rest of the unsold surplus electrical energy in the second time slot. This increases the profit gained by the user of the vehicle 20 as compared to when the surplus electrical energy is sold only in the first time slot.

By calculating the surplus electrical energy based on the second information and the fuel efficiency information, the information processing apparatus 10 can calculate the surplus electrical energy accurately in accordance with the actual usage of the vehicle 20 that follows the schedule of the vehicle 20 and with the fuel efficiency information of the vehicle 20. This makes it possible to avoid a situation in which the vehicle 20 cannot be used due to insufficient power within the schedule included in the second information. The user of the vehicle 20 can use the vehicle 20 as per the schedule included in the second information. The convenience for users of the vehicle 20 is thus maintained.

By correcting the fuel efficiency information based on the driving information during the calculation of the surplus electrical energy, the information processing apparatus 10 can accurately calculate the surplus electrical energy while also reflecting the driving tendency of the vehicle 20 by the driver. The information processing apparatus 10 is capable of accurately calculating the surplus electrical energy with optimized fuel efficiency information for each driver in accordance with the driving tendency. This makes it possible to avoid, for any user, a situation in which the vehicle 20 cannot be used due to insufficient power within the schedule included in the second information. The user of the vehicle 20 can use the vehicle 20 as per the schedule included in the second information. The convenience for users of the vehicle 20 is thus maintained.

By determining the surplus electrical energy to be sold among the surplus electrical energy based on the third information, the information processing apparatus 10 can determine the optimal surplus electrical energy to be sold in accordance with the power usage tendency in the vehicle 20. This makes it possible to avoid, for any user, a situation in which the vehicle 20 cannot be used due to insufficient power within the schedule included in the second information. The user of the vehicle 20 can use the vehicle 20 as per the schedule included in the second information. The convenience for users of the vehicle 20 is thus maintained.

By determining the surplus electrical energy to be sold among the surplus electrical energy based on the fourth information, the information processing apparatus 10 can determine the optimal surplus electrical energy to be sold in accordance with the preferences of the user of the vehicle 20 with respect to the sale of the surplus electrical energy. User satisfaction regarding the sale of surplus electrical energy is thereby increased. Accordingly, the usage frequency by users of the system for selling surplus electrical energy with the vehicle 20 will increase, facilitating the power supply from the vehicle 20 to the power system.

While the present disclosure has been described based on the drawings and examples, it should be noted that various changes and modifications can be made by those skilled in the art based on the present disclosure. Accordingly, such modifications and revisions are included within the scope of the present disclosure. For example, functions or the like included in each configuration, each step, or the like can be rearranged in a logically consistent manner, and a plurality of configurations, steps, or the like can be combined into one or divided.

For example, at least a portion of the processing operations executed in the information processing apparatus 10 in the above embodiment may be executed in the vehicle 20 or the server 30. For example, instead of the information processing apparatus 10, the vehicle 20 itself may execute the processing operations described above with regard to the information processing apparatus 10. At least a portion of the processing operations executed in the vehicle 20 or the server 30 may be executed in the information processing apparatus 10.

For example, a configuration that causes a general purpose electronic device such as a smartphone, a computer, or the like to function as the information processing apparatus 10 according to the above embodiment is possible. Specifically, a program in which processes for realizing the functions of the information processing apparatus 10 or the like according to the embodiment are written may be stored in a memory of the electronic device, and the program may be read and executed by a processor of the electronic device. Accordingly, in an embodiment, the present disclosure can also be implemented as a program executable by a processor.

Alternatively, an embodiment of the disclosure can also be implemented as a non-transitory computer readable medium storing a program executable by a single processor or a plurality of processors to cause the information processing apparatus 10 or the like according to the embodiment to execute the functions. It is to be understood that these are also included within the scope of the present disclosure.

For example, the information processing apparatus 10 described in the above embodiment may be mounted in the vehicle 20. In this case, the information processing apparatus 10 may directly communicate information with the vehicle 20 without using the network 40.

In the above embodiment, the information processing apparatus 10 is described as determining the first time slot with the highest electricity trading price among the time slots in which the vehicle 20 is connected to the electricity port during the target period as the time slot for selling at least a portion of the surplus electrical energy, but this example is not limiting. The information processing apparatus 10 may determine a time slot other than the first time slot among the time slots in which the vehicle 20 is connected to the power port during the target period as the time slot for selling at least a portion of the surplus electrical energy.

In the above embodiment, the information processing apparatus 10 is described as determining a second time slot for selling at least a portion of the surplus electrical energy that is not sold in the first time slot, but this example is not limiting. The information processing apparatus 10 need not execute such a process to determine the second time slot.

In the above embodiment, the information processing apparatus 10 is described as calculating the surplus electrical energy based on the second information and the fuel efficiency information, but this example is not limiting. The information processing apparatus 10 may calculate the surplus electrical energy based only on the second information. In this case, the information processing apparatus 10 may refer to the electricity efficiency information for a typical vehicle instead of the fuel efficiency information for the vehicle 20.

In the above embodiment, the information processing apparatus 10 is described as correcting the fuel efficiency information based on the driving information during the calculation of the surplus electrical energy. The information processing apparatus 10 need not execute such a correction process.

In the above embodiment, the information processing apparatus 10 is described as determining the surplus electrical energy to be sold among the surplus electrical energy based on the third information, but this example is not limiting. The information processing apparatus 10 need not execute such a determination process. In other words, the vehicle 20 may sell all of the surplus electrical energy.

The information processing apparatus 10 may execute the process of determining the surplus electrical energy to be sold among the surplus electrical energy based on the third information only once, and may then sell the same percentage of the surplus electrical energy in subsequent sales of the surplus electrical energy. This example is not limiting, however. The information processing apparatus 10 may execute the process of determining the surplus electrical energy to be sold among the surplus electrical energy based on the third information every time, and may update the percentage each time the surplus electrical energy is sold.

In the above embodiment, the information processing apparatus 10 has been described as determining the surplus electrical energy to be sold among the surplus electrical energy based on the fourth information, but this example is not limiting. The information processing apparatus 10 need not execute such a determination process. In other words, the vehicle 20 may sell all of the surplus electrical energy.

In the above embodiment, the vehicle 20 has been described as acquiring the fourth information in questionnaire format, but this example is not limiting. The vehicle 20 may acquire the fourth information by the user directly inputting the percentage of surplus electrical energy to be sold using the input interface 24.

The information processing apparatus 10 may execute the process of determining the surplus electrical energy to be sold among the surplus electrical energy based on the fourth information only once, and may then sell the same percentage of surplus electrical energy in subsequent sales of the surplus electrical energy. This example is not limiting, however. The information processing apparatus 10 may execute the process of determining the surplus electrical energy to be sold among the surplus electrical energy based on the fourth information every time, and may update the percentage each time the surplus electrical energy is sold.

In the above embodiment, the information processing apparatus 10 has been described as acquiring the first information indicating the electricity trading price by time slot during the target period from the server 30, but this example is not limiting. The information processing apparatus 10 need not acquire the information on the established electricity trading price in advance. Instead of such a configuration, the information processing apparatus 10 may acquire the first information by calculating a fluctuation trend of the electricity trading price based on past information on the electricity trading price, which fluctuates daily, and predicting how the electricity trading price will fluctuate on the next day.

In the above embodiment, the information processing apparatus 10 has been described as acquiring the second information from the vehicle 20 based on input provided by the user of the vehicle 20 using the input interface 24 of the vehicle 20, or based on an application on a terminal device such as a smartphone used by the user of the vehicle 20, but this example is not limiting. The information processing apparatus 10 may acquire the second information by predicting the schedule for the next day based on a past schedule of the user of the vehicle 20.

The vehicle 20 may be connected to the power port in a wired or wireless manner. When connected to the power port wirelessly, the vehicle 20 can also sell surplus electrical energy while driving.

In the above embodiment, the target period is described as including one day from 0:00 to 24:00, but this example is not limiting. The target period may be freely designated by the user of the vehicle 20.

In the above embodiment, the surplus electrical energy has been described as being sold from the vehicle 20 connected to the power port, but this example is not limiting. The object that is connected to the power port and from which the surplus electrical energy is sold is not limited to the vehicle 20 and may be any apparatus that operates using electricity as a power source, such as terminal devices including smartphones and PCs, and home appliances.

1. An information processing apparatus comprising a controller configured to:
acquire first information indicating an electricity trading price by time slot in a target period;
acquire second information indicating a schedule of a vehicle in the target period; and
determine, based on the first information and the second information, a time slot for selling at least a portion of surplus electrical energy stored in the vehicle.

2. The information processing apparatus of claim 1, wherein the controller is configured to determine a first time slot in which the electricity trading price is highest as the time slot for selling at least a portion of the surplus electrical energy.

3. The information processing apparatus of claim 2, wherein the controller is configured to determine, when the surplus electrical energy includes surplus electrical energy that is not sold during the first time slot, a second time slot for selling at least a portion of the surplus electrical energy that is not sold during the first time slot.

4. The information processing apparatus of claim 1, wherein the controller is configured to acquire fuel efficiency information on the vehicle, and calculate the surplus electrical energy based on the second information and the fuel efficiency information.

5. The information processing apparatus of claim 4, wherein the controller is configured to acquire driving information indicating a driving tendency of the vehicle by a driver, and correct the fuel efficiency information based on the driving information during calculation of the surplus electrical energy.

6. The information processing apparatus of claim 1, wherein the controller is configured to acquire third information indicating a power usage tendency in the vehicle, and determine the surplus electrical energy to be sold among the surplus electrical energy based on the third information.

7. The information processing apparatus of claim 1, wherein the controller is configured to acquire fourth information indicating a preference of a user of the vehicle regarding sale of the surplus electrical energy, and determine the surplus electrical energy to be sold among the surplus electrical energy based on the fourth information.

8. An information processing system comprising:
the information processing apparatus of claim 1;
a server configured to acquire the first information and transmit the first information to the information processing apparatus; and
the vehicle configured to acquire the second information and transmit the second information to the information processing apparatus.

9. A non-transitory computer readable medium storing a program executable by one or more processors to cause an information processing apparatus to execute functions, the functions comprising:
acquiring first information indicating an electricity trading price by time slot in a target period;
acquiring second information indicating a schedule of a vehicle in the target period; and
determining, based on the first information and the second information, a time slot for selling at least a portion of surplus electrical energy stored in the vehicle.

10. The non-transitory computer readable medium of claim 9, wherein the functions comprise determining a first time slot in which the electricity trading price is highest as the time slot for selling at least a portion of the surplus electrical energy

11. The non-transitory computer readable medium of claim 10, wherein the functions comprise determining, when the surplus electrical energy includes surplus electrical energy that is not sold during the first time slot, a second time slot for selling at least a portion of the surplus electrical energy that is not sold during the first time slot.

12. The non-transitory computer readable medium of claim 9, wherein the functions comprise acquiring fuel efficiency information on the vehicle, and calculating the surplus electrical energy based on the second information and the fuel efficiency information.

13. The non-transitory computer readable medium of claim 12, wherein the functions comprise acquiring driving information indicating a driving tendency of the vehicle by a driver, and correcting the fuel efficiency information based on the driving information during calculation of the surplus electrical energy.

14. The non-transitory computer readable medium of claim 9, wherein the functions comprise acquiring third information indicating a power usage tendency in the vehicle, and determining the surplus electrical energy to be sold among the surplus electrical energy based on the third information.

15. A vehicle comprising a controller configured to:
acquire first information indicating an electricity trading price by time slot in a target period;
acquire second information indicating a schedule of the vehicle in the target period; and
determine, based on the first information and the second information, a time slot for selling at least a portion of surplus electrical energy stored in the vehicle.

16. The vehicle of claim 15, wherein the controller is configured to determine a first time slot in which the electricity trading price is highest as the time slot for selling at least a portion of the surplus electrical energy.

17. The vehicle of claim 16, wherein the controller is configured to determine, when the surplus electrical energy includes surplus electrical energy that is not sold during the first time slot, a second time slot for selling at least a portion of the surplus electrical energy that is not sold during the first time slot.

18. The vehicle of claim 15, wherein the controller is configured to acquire fuel efficiency information on the vehicle, and calculate the surplus electrical energy based on the second information and the fuel efficiency information.

19. The vehicle of claim 18, wherein the controller is configured to acquire driving information indicating a driving tendency of the vehicle by a driver, and correct the fuel efficiency information based on the driving information during calculation of the surplus electrical energy.

20. The vehicle of claim 15, wherein the controller is configured to acquire third information indicating a power usage tendency in the vehicle, and determine the surplus electrical energy to be sold among the surplus electrical energy based on the third information.
